(19) United States
(12) Patent Application Publication
(10) Pub. No.: US 2003/0223673 A1
(43) Pub. Date: Dec. 4, 2003

(54) Integrated optical waveguide structures

(76) Inventors: Anthony F. Garito, Radnor, PA (US); Renyuan Gao, Wayne, PA (US); Renfeng Gao, Phoenixville, PA (US); Aydin Yeniay, Wayne, PA (US); Kazuya Takayama, Phoenixville, PA (US); Yu-Ling Hsiao, Collegeville, PA (US); Robert Norwood, West Chester, PA (US)

Correspondence Address: Finnegan, Henderson, Farabow,, Garrett & Dunner, L.L.P., 1300 I Street, N.W., Washington, DC, 20005-3315, US

(21) Appl. No.: 10/388,524

(22) Filed: Mar. 17, 2003

Related U.S. Application Data
(60) Provisional application No. 60/364,936, filed on Mar. 15, 2002.

(51) Int. Cl. G02B 6/12

(52) U.S. Cl. 385/14

(57) ABSTRACT

A multifunctional integrated optical waveguide is provided. The planar optical waveguide structure includes an active gain medium for optical amplification, and a passive component(s) (i.e. arrayed waveguide grating, splitter, and tap) for processing the signal (i.e. multiplexing, demultiplexing, monitoring, add-dropping, routing and splits) on a solid substrate.

### CROSS-REFERENCE TO RELATED APPLICATION

This application claims the benefit of priority under 35 U.S.C. § 119(e) to U.S. Provisional Patent Application 60/364,936 filed Mar. 15, 2002, which is herein incorporated by reference.

### FIELD OF THE INVENTION

The current invention relates to integrated optical waveguide structures that provide a plurality of optical functions on a single optical chip.

### BACKGROUND OF THE INVENTION

Since the introduction of erbium-doped fiber amplifiers (EDFAs), the last decade has witnessed the emergence of single-mode glass optical fibers as the standard data transmission medium for wide area networks (WANs), especially in terrestrial and transoceanic communication backbones. The success of the single-mode glass optical fibers in long-haul communication backbones has given rise to the new technology of optical networking. The universal objective is to integrate voice video, and data streams over all-optical systems as communication signals make their way from WANs down to smaller local area networks (LANs) of Metro and Access networks, down to the curb (FTTC), home (FTTH), and finally arriving to the end user by fiber to the desktop (FTTD). Examples are the recent explosion of the Internet and use of the World Wide Web, which are demanding vastly higher bandwidth performance in short and medium-distance applications. Yet, as the optical network nears the end user starting at the LAN stage, the network is characterized by numerous multiplexing, demultiplexing, monitoring, add-drops and splits of the input signals. This feature represents a fundamental problem for optical networks. Each of these optical signal processes (i.e. multiplexing, demultiplexing, add-drops, monitoring and splits) requires a dedicated optical device such as an arrayed waveguide grating (AWG), splitter or tap. Each time the input signal is processed by means of these device(s), the signal strength per channel is naturally reduced. This natural characteristic of optical networks requires, not only amplification within the input signal bandwidth, but also building and designing many passive components. However, it is cumbersome to construct and manage separate functional devices within the network. As a potential solution to these issues, passive and active planar optical waveguides have been attracting great interest because of their potential integration capability with passive and active devices on a single chip for realizing advanced, multi-functional, low cost integrated optical waveguides.

The key to an optical signal amplification device is the gain medium. Gain media are typically made by doping rare earth ions into the core of an optical fiber. However, rare earth doped optical fiber has the disadvantage of high-cost, long length and difficulty of integration with other optical components, such as optical couplers, splitters, detectors, and diode lasers. The devices are, therefore, bulky and have a high cost of manufacturing. As a cost-effective alternative to doped fibers, doped waveguides can be used as an amplification medium. Waveguides are able to amplify a light signal over a significantly smaller area than fibers.

Planar optical waveguides can be formed in random glassy media, such as inorganic glasses and polymers, by using a core layer and a cladding layer with the core layer refractive index slightly higher than that of the cladding layer across the near infrared region of the optical telecommunication window from approximately 1200 to 1700 nanometers. A general approach to making such optical waveguides is to dispose an undercladding layer on a silicon substrate and then a core layer on top of the undercladding layer. The core layer subsequently undergoes patterning, such as by lithography and etching processes, from which a rectangular cross-section channel is formed. An overcladding layer is then disposed on top of the waveguide core and the exposed undercladding layer.

In order to achieve a desired 10 dB-30 dB signal gain in the amplifier, or to achieve laser output in the waveguide laser, a relatively high concentration of the rare earth ions are required, since the waveguide substrate (e.g. a four inch silicon wafer) can only accommodate a straight line waveguide with a length that is no longer than the waveguide substrate diameter. High concentration of rare earth ions can lead to problems such as ion clustering and lifetime quenching, which reduce the amplifier performance. Furthermore, the straight line amplification waveguide can be required to be more than 10 cm long, which requires the dimension of the amplifier device to be greater than 10 cm in length, thus making it impractical to build the amplifier device more compact. The prior art, as exemplified in U.S. Pat. No. 5,039,191 (Blonder et al.), U.S. Pat. No. 6,043,929 (Delavaux et al.), U.S. Pat. No. 5,119,460 (Bruce et al.), PCT Publication WO 00/05788 (Lawrence et al.), and J. Shmulovich, A. Wong, Y. H. Wong, P. C. Becker, A. J. Bruce, R. Adar “Er³⁺ Glass Waveguide Amplifier at 1.55 μm on Silicon,” Electron. Lett., Vol. 28, pp.1181-1182, 1992, all disclose such straight line waveguides.

It would be beneficial to have a curved channel waveguide that is contained on a relatively small area on a substrate, hence increasing the amplification channel waveguide length and reducing the overall size of the amplifier. Bruce et al., as well as M. Ohashi and K. Shiraki, “Bending Loss Effect on Signal Gain in an Er³⁺ Doped Fiber Amplifier,” IEEE Photon. Technol. Lett., Vol. 4., pp.192-194, 1992, discloses a curved zig-zag shaped channel waveguide to increase the channel length. However, this approach creates the problem of high bending losses at turning regions in the curved waveguide. The bending radius is R_{bending}=(½n) R_{substrate} where n is the number of channel waveguide curve turning regions. Due to the high bending curvature, or small bending radius, the bending loss of such waveguide is extremely high, resulting in low signal gain and limited usable waveguide channel length. Another approach is to use a spiral type waveguide with a plurality of 90° bends to reduce the amount of area required for the waveguide. However, because of the tight bend radius at each of the 90° bends, a substantial amount of light is lost at each bend.

Due to the disadvantages of the prior art described above, for amplifier gain medium, an optimized bending shape is desired when long length is required to achieve a more compact, integrated amplifier device at a lower manufacturing cost and without the losses exhibited by current curved waveguides.

Various optical devices such as integrated splitters, couplers, arrayed waveguide gratings, and optical waveguide amplifiers can be formed with optical waveguides. In phase sensitive optical waveguide devices, such as directional couplers, Mach-Zender interferometers, arrayed waveguide gratings (AWG), etc., the wavelength responses of the devices vary significantly with environmental temperature changes. This variance is due to the large thermal expansion coefficient and the large optic coefficient of polymer materials. Due to these large coefficients, operation of these optical waveguide devices require temperature control, thereby increasing device complexity and manufacturing cost.

Keil et al., “Athermal all-polymer arrayed-waveguide grating multiplexer,” Electronics Letters, Vol. 37, No. 9, Apr. 26, 2001, discloses fluoroacrylate-type polymers such as a terpolymer of pentafluorostyrene, trifluoroethylmethacrylate, and glycidylmethacrylate disposed on a polymer substrate as AWG's. However, these fluoroacrylate-type polymers contain numerous C—H bonds. Polymers with C—H bonds typically have high absorption in the infrared region where the optical communication signals reside, at approximately 1.5 μm. This absorption causes optical communication signal loss.

Suh et al., U.S. Pat. No. 6,100,371, discloses using a polyimide polymer. However, the polyimides disclosed by Suh et al. all contain numerous C═O bonds, which also lead to unwanted vibrational overtones in the infrared region.

Joo-Heon Ahn et al.,“Polymeric 1×8 Arrayed Waveguide Grating Multiplexer using Fluorinated Poly(ether ketone) at 1550 nm,” Proceedings of SPIE, Terahertz and Gigahertz Photonics, Vol. 3795, pg. 568-575, Denver, Colo. (July 1999), discloses a waveguide grating having a silicon substrate and using synthesized polyetherketone as the core material. These devices exhibited large polarization dependence due to the birefringence of these materials.

It is desirable to have waveguide devices that: (1) are intrinsically athermal (the wavelength responses of the devices are insensitive to environmental temperature changes).(2)exhibit low absorption loss around the 1.5 μm infrared communication wavelength, and(3) exhibit a minimum amount of birefringence.

It is even more desirable to have multi-functional active and passive waveguide devices integrated on a single platform that are athermal, exhibit low absorption loss around the 1.5 μm infrared communication wavelength, and exhibit a minimum amount of birefringence.

### SUMMARY OF THE INVENTION

The present invention is an integrated optical device formed from a random glassy medium comprising:a generally planar substrate; and a plurality of integrated waveguide devices disposed on the substrate.

### BRIEF DESCRIPTION OF THE DRAWINGS

The accompanying drawings, which are incorporated herein and constitute part of this specification, illustrate unlimitingembodiments of the invention, and, together with the general description given above and the detailed description given below, serve to explain the features of the invention. In the drawings:

FIG. 1 is a perspective view of an integrated optical device including an amplifying gain medium and an arrayed waveguide grating in accordance with a first embodiment of the present invention.

FIG. 2 is a schematic view of the integrated optical device shown in FIG. 1.

FIG. 3 is a perspective view of an integrated optical device including an amplifying gain medium and an optical splitter in accordance with a second embodiment of the present invention.

FIG. 4 is a schematic view of the integrated optical device shown in FIG. 3.

FIG. 5 is a schematic view of an integrated optical device including an optical splitter and a plurality of optical gain media in accordance with a third embodiment of the present invention.

FIG. 6 is a schematic view of an integrated optical device including an optical tap, an optical gain medium, an arrayed waveguide grating and an optical receiver array in accordance with a fourth embodiment of the present invention.

### DETAILED DESCRIPTION OF THE INVENTION

The present invention provides an integrated optical waveguide system which is comprised of a channel optical waveguide amplifier, as an active device, and a passive device disposed on a single substrate. The passive device may be an AWG, a splitter, or both. The optical waveguide channel amplifier medium includes a generally circular spiraling portion having connected end to the passive component.

In one embodiment, an integrated optical device is formed from a random glassy medium comprising a generally planar substrate, and a plurality of integrated waveguide devices disposed on the substrate, wherein the plurality of integrated waveguide devices are chosen from optical amplifier gain media, optical splitters, optical combiners, optical multiplexers, optical demultiplexers, optical switches, optical filters, taps, receiver arrays, and arrayed waveguide gratings.

The generally planar substrate can be chosen from an inorganic glass, a polymer, or a polymer nanocomposite. The polymer is generally chosen from polycarbonate, acrylic, polymethyl methacrylate, cellulosic, thermoplastic elastomer, ethylene butyl acrylate, ethylene vinyl alcohol, ethylene tetrafluoroethylene, fluorinated ethylene propylene, polyetherimide, polyethersulfone, polyetheretherketone, polyperfluoroalkoxyethylene, nylon, polybenzimidazole, polyester, polyethylene, polynorbornene, polyimide, polystyrene, polysulfone, polyvinyl chloride, polyvinylidene fluoride, an ABS polymer (such as polyacrylonitrile butadiene styrene), acetal copolymer, poly [2,2-bistrifluoromethyl-4,5-difluoro-1,3-dioxole-co-tetrafluoroethylene], poly[2,3-(perfluoroalkenyl) perfluorotetrahydrofuran], poly[2,2,4-trifluoro-5-trifluoromethoxy-1,3-dioxole-co-tetrafluoroethylene], and any other thermoplastic polymers; and thermoset polymers. The thermoset polymers can be chosen from diallyl phthalate, epoxy, furan, phenolic, thermoset polyester, polyurethane, and vinyl ester.

One class of composite materials includes nanoparticles distributed within a host matrix material, as exemplified above. Nanoparticles are particles of a material that have a size measured on a nanometer scale. Generally, nanoparticles are larger than a cluster (which might be only a few hundred atoms in some cases), but with a relatively large surface area-to-bulk volume ratio. While most nanoparticles have a size from about 10 nm to about 500 nm, the term nanoparticles can cover particles having sizes that fall outside of this range. For example, particles having a size as small as about 1 nm and as large as about 1×10³ nm could still be considered nanoparticles. By introducing nanoparticles into optically transparent host matrix, the absorption and scattering losses due to the nanoparticles may add to the optical loss. In order to keep the optical loss to a minimum, in addition to controlling the loss contribution from the host matrix, it is essential to control the absorption and scattering loss from the nanoparticles doped into the host matrix for optical applications.

Nanoparticles can be made from a wide array of materials. Among these materials examples include, transition metals, rare-earth metals, group VA elements, polymers, dyes, semiconductors, alkaline earth metals, alkali metals, group IIIA elements, and group IVA elements.

Nanoparticles can be made from a wide array of materials. Among these materials examples include metal, glass, ceramics, refractory materials, dielectric materials, carbon or graphite, natural and synthetic polymers including plastics and elastomers, dyes, ion, alloy, compound, composite, or complex of transition metal elements, rare-earth metal elements, group VA elements, semiconductors, alkaline earth metal elements, alkali metal elements, group IIIA elements, and group IVA elements or polymers and dyes.

Further, the materials may be crystalline, amorphous, or mixtures, or combinations of such structures. Nanoparticles may be bare, coated, bare core-shell, coated core-shell, Further, nanoparticles themselves may considered a nanoparticle matrix, which may comprise a wide array of materials, single elements, mixtures of elements, stoichiometric or non-stoichiometric compounds. The materials may be crystalline, amorphous, or mixtures, or combinations of such structures.

A plurality of nanoparticles may include an outer coating layer, which at least partially coats nanoparticles and inhibits their agglomeration. Suitable coating materials may have a tail group, which is compatible with the host matrix, and a head group, that could attach to the surface of the particles either through physical adsorption or chemical reaction. The nanoparticles according to the present invention may be doped with an effective amount of dopant material. An effective amount is that amount necessary to achieve the desired result. The nanoparticles of doped glassy media, single crystal, or polymer are embedded in the host matrix core material. The active nanoparticles may be randomly and uniformly distributed. The nano-particles of rare-earth doped, or co-doped, glasses, single crystals, organic dyes, or polymers are embedded in the polymer core material. In cases where there is interface delamination due to mismatches of mechanical, chemical, or thermal properties between the nanoparticles and the surrounding polymer core host matrix, a compliance layer may be coated on the nanoparticles to enhance the interface properties between the nanoparticles and the host matrix polymer core material.

As stated, the nanoparticles may include an outer layer. As used herein, the term layer is a relatively thin coating on the outer surface of an inner core (or another inner layer) that is sufficient to impart different characteristics to the outer surface. The layer need not be continuous or thick to be an effective layer, although it may be both continuous and thick in certain embodiments.

The presence of the nanoparticles can affect other properties of the composite material. For example, for optical applications, the nanoparticle material may be selected according to a particular, desired index of refraction. For certain structural applications, the type of material used to form the nanoparticles may be selected according to its thermal properties, or coefficient of thermal expansion. Still other applications may depend on the mechanical, magnetic, electrical, thermo-optic, magneto-optic, electro-optic or acousto-optic properties of the material used to form nanoparticles.

Several classes of materials may be used to form nanoparticles depending upon the effect the nanoparticles are to have on the properties of the composite containing them. In one embodiment, nanoparticles may include one or more active materials, which allow the composite to be a gain medium. Active materials act as gain media toward a light signal as the light signal encounters the active material. Active materials may include transition metal elements, rare-earth metal elements, the actinide element uranium, group VA elements, semiconductors, and group IVA elements in the forms of ions, alloys, compounds, composites, complexes, chromophores, dyes or polymers. Examples of such active materials include but are not limited to Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, V²⁺, V³⁺, Cr²⁺, Cr³⁺, Cr⁴⁺, Mn⁵⁺, Co²⁺, Fe²⁺, Ni²⁺, Ti³⁺, U³⁺, and Bi³⁺, as well as the semiconductors such as Si, Ge, SiGe, GaP, GaAs, InP, InAs, InSb, PbSe, PbTe. Active materials can also comprise combinations of the above mentioned materials.

The material that forms the matrix of nanoparticle may be in the form of ions, alloys, compounds, composites, complexes, chromophores, dyes or polymers, and may comprise the following: an oxide, phosphate, halophosphate, phosphinate, arsenate, sulfate, borate, aluminate, gallate, silicate, germanate, vanadate, niobate, tantalaite, tungstate, molybdate, alkalihalogenate, halogenide, nitride, selenide, sulfide, sulfoselenide, tetrafluoroborate, hexafluorophosphate, phosphonate, and oxysulfide.

In certain embodiments, the transition metal ions V²⁺, V³⁺, Cr²⁺, Cr³⁺, Cr⁴⁺, Mn⁵⁺, Co²⁺, Fe²⁺, Ni²⁺, B³⁺ and Ti³⁺, for example, alone or together may be incorporated in a nanoparticle for gain media ranging from about 0.61 μm to 3.5 μm.

In additional embodiments, the rare earth ions Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺ and Yb³⁺, for example, alone or together may be incorporated in a nanoparticle for gain media ranging from about 0.17 μm to 7.2 μm.

In further embodiments, the metal ions U³⁺, and Bi³⁺ for example, alone or together may be incorporated in a nanoparticle for gain media ranging from about 2.2 μm to 2.8 μm, and near 1.3 μm, respectively.

In certain embodiments, Er³⁺ and Yb³⁺, for example, alone or together may be incorporated in a nanoparticle for gain media ranging from about 0.9 μm to 1.1 μm and from about 1.5 μm to about 1.6 μm.

In certain embodiments, Er³⁺ and Cr⁴⁺, for example, alone or together may be incorporated in a nanoparticle for gain media ranging from about 1.2 μm to 1.4 μm and from about 1.5 μm to about 1.6 μm.

In certain embodiments, Er³⁺ is alone or together co-doped with other active ions in crystal nanoparticles for amplification ranging from about 1.5 μm to about 1.6 μm, further about 1.55 μm. In another embodiment, several separate species of nanoparticles containing an active ion such as Er³⁺, and other active ions may be doped into the polymer hosts. For example, Yb³⁺ can be co-doped into the nanoparticles containing Er³⁺ to increase the absorption cross section for the pump laser. Additionally, Yb³⁺ can be doped into the polymer hosts separate from the active Er³⁺ nanoparticles to achieve the same sensitization effect.

In certain embodiments, Cr⁴⁺ is alone or together co-doped with other active ions in crystal nanoparticles for amplification ranging from about 1.2 μm to about 1.4 μm, further about 1.31 μm. In another embodiment, several separate species of nanoparticles containing an active ion such as Cr⁴⁺, and other active ions may be doped into the polymer hosts. For example, Yb³⁺ can be co-doped into the nanoparticles containing Cr⁴⁺ to increase the absorption cross section for the pump laser. Additionally, Yb³⁺ can be doped into the polymer hosts separate from the active Cr⁴⁺ nanoparticles to achieve the same sensitization effect.

In certain embodiments, Er and Cr⁴⁺ are together or co-doped with other active ions in crystal nanoparticles for amplification ranging from about 1.2 μm to about 1.4 μm and from 1.5 μm to about 1.6 μm, further about 1.3 μm and about 1.55 μm. In another embodiment, several separate species of nanoparticles containing an active ion such as Er and Cr⁴⁺, and other active ions may be doped into the polymer hosts. For example, Yb can be co-doped into the nanoparticles containing Er or Cr⁴⁺ to increase the absorption cross section for the pump laser. Additionally, Yb can be doped into the polymer hosts separate from the active Er or Cr⁴⁺ nanoparticles to achieve the same sensitization effect.

In certain embodiments, Pr³⁺, Dy³⁺, Nd³⁺, and Bi³⁺ alone or together may be incorporated in a nanoparticle for gain media ranging from about 1.27 μm to about 1.35 μm, and further about 1.3 μm, and yet further about 1.31 μm.

In another embodiment, Pr³⁺, Dy³⁺, and Nd³⁺ alone or together with other rare-earth elements, such as Yb³⁺, may be incorporated in a nanoparticle for gain media ranging from about 1.27 μm to about 1.35 μm, and further about 1.3 μm, and yet further about 1.31 μm.

The material that forms the matrix of nanoparticle may be in the form of an ion, alloy, compound, or complex, and may comprise the following: an oxide, phosphate, halophosphate, phosphinate, arsenate, sulfate, borate, aluminate, gallate, silicate, germanate, vanadate, niobate, tantalite, tungstate, molybdate, alkalihalogenate, halogenide, nitride, selenide, sulfide, sulfoselenide, tetrafluoroborate, hexafluorophosphate, phosphonate, and oxysulfide.

In certain embodiments, semiconductor materials, for example, Si, Ge, SiGe, GaP, GaAs, GaN, InP, InAs, InSb, PbSe, PbTe, InGaAs, and other stoichiometries as well as compositions, alone, or together, or doped with an appropriate ion may be incorporated in a nanoparticle for gain media ranging from about 0.4 μm to 1.6 μm.

Metal containing materials such as metal chalocogenides, metal salts, transition metals, transition metal complexes, transition metal containing compounds, transition metal oxides, and organic dyes, such as, for example, Rodamin-B, DCM, Nile red, DR-19, and DR-1, and polymers may be used. ZnS, or PbS doped with a rare-earth or transition metal for gain media can also be used to form nanoparticles.

Several classes of materials may be used to form nanoparticles depending upon the effect the nanoparticles are to have on the properties of the composite containing them. In one embodiment, nanoparticles may include one or more active materials, which allow the composite to be a novel optical medium. Active materials change the index of refraction of the composite material. Active materials may include nanoparticles made from metals, semiconductors, dielectric insulators, and various forms and combinations of ions, alloys, compounds, composites, complexes, chromophores, dyes or polymers.

In addition to the materials mentioned, still other materials are useful as nanoparticles. For example, the nanoparticles, themselves, may comprise a polymer. In an exemplary embodiment of the invention, the polymer nanoparticles comprise polymers that contain functional groups that can bind ions, such as rare-earth ions. Such polymers include homopolymers or copolymers of vinyl, acrylic, vinyl aromatic, vinyl esters, alpha beta unsaturated acid esters, unsaturated carboxylic acid esters, vinyl chloride, vinylidene chloride, and diene monomers. The reactive groups of these polymers may comprise any of the following: POOH, POSH, PSSH, OH, SO₃H, SO₃R, SO₄R, COOH, NH₂, NHR, NR₂, CONH₂, NH—NH₂, and others, where R may be chosen from linear or branched hydrocarbon-based chains, possibly forming at least one carbon-based ring, being saturated and unsaturated, aryl, alkyl, alkylene, siloxane, silane, ether, polyether, thioeter, silylene, and silazane.

The polymers for use as nanoparticles may alternatively comprise main chain polymers containing rare-earth ions in the polymer backbone, or side chain or cross-linked polymers containing the above-mentioned functional groups. The polymers may be highly halogenated yet immscible with the host matrix polymer. For example, nanoparticles of inorganic polymer, prepared by reacting erbium chloride with perfluorodioctylphosphinic acid, exhibit high crystallinity and are immscible with poly[2,3-(perfluoroalkenyl) perfluorotetrahydrofuran]. Blending these nanoparticles with the fluorinated polymer host will lead to a nanocomposite. Additionally, the nanoparticles may comprise organic dye molecules, ionic forms of these dye molecules, or polymers containing these dye molecules in the main chain or side chain, or cross-linked polymers. When the nanoparticles comprise polymers that are not halogenated, they may be optionally coated with a halogenated coating as described herein.

Depending on the end use, the nanoparticles according to the present invention may be bare, or contain at least one outer layer. The nanoparticles may include an outer layer, which may be used to protect nanoparticle from moisture or other potentially detrimental substances. Additionally, layer may also prevent agglomeration. Agglomeration is a problem when making composite materials that include nanoparticles distributed within a matrix material.

In one embodiment, by selecting a layer of a material that is compatible with a given host matrix material, layer may eliminate the interfacial energy between the nanoparticle surfaces and host matrix. As a result, the nanoparticles in the composite material do not tend to agglomerate to minimize the interfacial surface area/surface energy that would exist between uncoated nanoparticles and host matrix material. The layer, therefore, enables dispersion of nanoparticles into the host matrix material without agglomeration of the nanoparticles.

When the outer layer is halogenated, it may comprise at least one halogen chosen from fluorine, chlorine, and bromine. In an exemplary embodiment of the present invention, the halogenated outer layer may include, for example, halogenated polyphosphates, halogenated phosphates, halogenated phosphinates, halogenated thiophosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated disulfide, halogenated thiols, and halogenated alkylcyanide. While fluorine analogs of these materials can be used, analogs of these materials incorporating halogens other than fluorine, as well as hydrogen, may also be employed in outer layer.

In addition to protecting the nanoparticles and suppressing agglomeration, layer may also be designed to interact with the surfaces of nanoparticles. For example, halogenated outer layer may comprise a material, such as one of the above listed layers, which reacts with and neutralizes an undesirable radical group, for example OH or esters, that may be found on the surfaces of nanoparticles. In this way, layer may prevent the undesirable radical from reacting with host matrix. Coating may also prevent fluorescence quenching in the case of fluorescence nanoparticles.

Coatings on nanoparticles are not limited to a single layer, such as a halogenated outer coating layer. Rather, the nanoparticles may be coated with a plurality of layers.

Nanoparticles may be coated in several ways. For example, nanoparticles may be coated in situ, or, in other words, during the formation process. The nanoparticles may be formed (for example by electro-spray) in the presence of a coating material. In this way, once nanoparticles have dried to form an aerosol, they may already include layer of the desired host material.

In one embodiment, the layer may be formed by placing the nanoparticles into direct contact with the coating material. For example, nanoparticles may be dispersed into a solution including a halogenated coating material. In some embodiments, nanoparticles may include a residual coating left over from the formation process. In these instances, nanoparticles may be placed into a solvent including constituents for forming the outer coating layer. Once in the solvent, a chemical replacement reaction may be performed to substitute the outer coating layer for the preexisting coating on the plurality of nanoparticles. In one embodiment, nanoparticles may be coated with a coating in a gas phase reaction, for example, in a gas phase reaction of hexamethyidisilazane.

In another embodiment, the nanoparticles may be dispersed by co-dissolving them, and the host matrix, in a solvent (forming a solution), spin coating the solution onto a substrate, and evaporating the solvent from the solution.

In another embodiment, the nanoparticles may be dispersed in a monomer matrix, which is polymerized after the dispersion. For example, metal oxide nanoparticles can be dispersed into a liquid monomer under sonication. The resulting mixture is then degassed and mixed with either a thermal intiator or a photo-initiator, such as azo, peracid, peroxide, or redox type intiators. The mixture is then heated to induce polymerization forming a polymer nanocomposite. Additionally, the pre-polymerized mixture can be spin-coated onto a substrate followed by thermally or photo-induced polymerization to form a nanocomposite thin film.

In yet another embodiment, coatings may be in the form of a halogenated monomer. Once the monomers are absorbed on the surface of the particles, they can be polymerized or cross-linked. Additionally, coatings in the form of polymers can be made by subjecting the particles, under plasma, in the presence of halogenated monomers, to form coated nanoparticles with plasma induced polymerization of the particle surface. The coating techniques described are not intended to be an exhaustive list. Indeed, other coating techniques known to one of ordinary skill in the art may be used.

In one embodiment, the integrated optical device may be athermal. In other words, the product of the thermo-optic coefficient of the polymer waveguide core and the reciprocal of the refractive index of the polymer waveguide core are approximately equal to the negative value of the coefficient of thermal expansion.

When the integrated optical device according to an embodiment of the invention comprises a gain media, it may comprise dopants chosen from rare earth ions, transition metal ions or nanoparticles for desired bandwidth amplification. Appropriate dopants for the desired bandwidth include rare earth ions are chosen from Erbium for C-L band, Thulium for S-Band, and Praseodymium for O-band, as well as Chromium for O-band.

In another embodiment, the integrated optical device exhibits absorption losses less than or approximately 0.1 dB/cm across the range of wavelength from about 1200 nm to about 1700 nm.

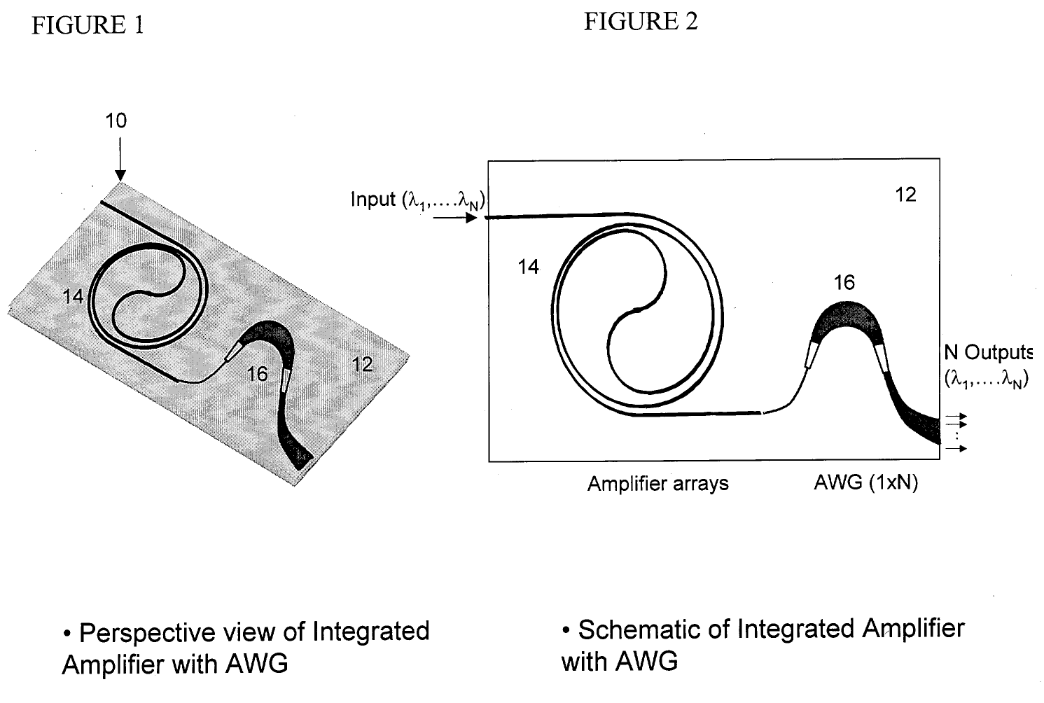

In the drawings, like numerals indicate like elements throughout. Referring to FIG. 1, an integrated optical waveguide device 10 according to an embodiment of the present invention is disclosed. In an embodiment, the waveguide device 10 includes a substrate 12 with a plurality of waveguide functional devices 14, 16 disposed on the substrate 12. The devices 14, 16 are formed on the substrate 12 using photolithographic processes as are well known by those skilled in the art. In an embodiment, the devices are optical polymers as disclosed in U.S. patent application Ser. No. 10/243,833, “Athermal Polymer Optical Waveguide on Polymer Substrate”, which is owned by the assignee of the current invention and which is incorporated herein by reference in its entirety.

Polymers to be used as optical waveguide material should have low absorption loss in the range of telecommunication wavelengths (1200 nm˜1700 nm). C—H bonds in the typical organic polymers exhibit a large vibrational overtone absorption near the C-band telecommunication range band (between 1530 nm and 1565 nm). One method to eliminate optical loss is to replace the C—H bonds with C—F bonds, which shifts the vibrational overtones toward longer wavelength leaving a low loss optical window in the C-band. However, to push the performance of the optical polymer to exhibit a waveguide loss of less than or approximately 0.1 dB/cm across the telecommunication range, it is necessary to minimize the presence of other functional groups, which contribute to additional absorption losses. For example, the presence of O—H and C═O bonds in the polymer also contribute to the fundamental optical loss (see Table 1).

TABLE 1
Wavelengths and intensities of some important vibrational overtones

| Bond | N | Wavelength (nm) | Intensity (relative) |
|---|---|---|---|
| C—H | 1 | 3390 | 1 |
| C—H | 2 | 1729 | 7.2 × 10⁻² |
| C—H | 3 | 1176 | 6.8 × 10⁻³ |
| C—F | 5 | 1626 | 6.4 × 10⁻⁶ |
| C—F | 6 | 1361 | 1.9 × 10⁻⁷ |
| C—F | 7 | 1171 | 6.4 × 10⁻⁹ |
| C═O | 3 | 1836 | 1.2 × 10⁻² |
| C═O | 4 | 1382 | 4.3 × 10⁻⁴ |
| C═O | 5 | 1113 | 1.8 × 10⁻⁵ |
| O—H | 2 | 1438 | 7.2 × 10⁻² |

Similarly, functional groups such as Si—H, S—H, N—H, P—H, C═N, C═C, C═S, N═O, C≡N, and C≡C, with their fundamental vibrational frequencies above 1400 cm⁻¹, also exhibit undesirable vibrational overtones extending into the telecommunication wavelength range.

In addition to low absorption requirements in polymer waveguide materials, optical polymers for AWG should also exhibit very low polarization dependence so that the polarization dependent losses and polarization dependent shifts in the filter performance are minimized. The polarization dependence property of the polymer waveguide materials is directly related to the birefringence property of these polymers. Birefringence is defined as the difference in the refractive indexes in the two directions perpendicular to the direction of optical propagation. The birefringence may derive from either inherent material properties or it can be induced by means of externally applied force fields. Polyimide type polymers, containing aromatic rings in the main chain, generally exhibit a large birefringence which makes them undesirable as optical waveguide materials.

As shown in FIG. 1, the functional devices can be an optical amplifier gain medium 14, as disclosed in U.S. patent application Ser. No. 09/877,871, filed Jun. 8, 2001, which is owned by the assignee of the current invention and which is incorporated by reference herein in its entirety, as well as an arrayed waveguide grating (AWG) 16. Here, the waveguide amplifier medium 14 uses a generally circular double spiral structure that maximizes the usage of the area of a substrate 12 and maximizes the bending radius of a waveguide disposed on the substrate 12. On a substrate of a defined size, the usable length of the optimized curved amplifier waveguide 14 is not limited by the substrate length or diameter. The bending radius on the waveguide amplifier 14 is about half of the radius R_{sub} of the substrate 12 in the center part of the waveguide and is approximately equal to the radius R_{sub} of the substrate 12 in the outer part of the waveguide. The width of each channel (preferably approximately 5 micrometers) of the waveguide 14 is much smaller than the diameter or the width of the substrate 12 (e.g. about 10-15 centimeters), and the separation between channels of the waveguide 14 is also much smaller than the diameter or the width of the substrate 12. As a result, the separation between adjacent channels of the waveguide can be as small as approximately 100 micrometers. Although only several winding channels are shown in FIGS. 1 and 2, the number of winding channels can be on the order of hundreds, greatly increasing the amplification channel length, and at the same time maintaining the relatively large bending radius necessary for desired small bending losses.

In an embodiment, the substrate 12 is chosen from polycarbonate, acrylic, polymethyl methacrylate, cellulosic, thermoplastic elastomer, ethylene butyl acrylate, ethylene vinyl alcohol, ethylene tetrafluoroethylene, fluorinated ethylene propylene, polyetherimide, polyethersulfone, polyetheretherketone, polyperfluoroalkoxyethylene, nylon, polybenzimidazole, polyester, polyethylene, polynorbornene, polyimide, polystyrene, polysulfone, polyvinyl chloride, polyvinylidene fluoride, an ABS polymer (such as polyacrylonitrile butadiene styrene), acetal copolymer, poly [2,2-bistrifluoromethyl-4,5-difluoro-1,3-dioxole-co-tetrafluoroethylene], poly[2,3-(perfluoroalkenyl) perfluorotetrahydrofuran], poly[2,2,4-trifluoro-5-trifluoromethoxy-1,3-dioxole-co-tetrafluoroethylene], and any other thermoplastic polymers; and thermoset polymers, such as diallyl phthalate, epoxy, furan, phenolic, thermoset polyester, polyurethane, and vinyl ester. However, those skilled in the art will recognize that other polymers can be used. The substrate 10 can be manufactured from any of the above-listed polymers or combinations or blends of the above-listed polymers.

For temperature independent performance of the present system, an athermal platform is required as previously demonstrated in U.S. patent application Ser. No. 10/243,833, “Athermal Polymer Optical Waveguide on Polymer Substrate,”, which is owned by the assignee of the current invention. The wavelength response of phase sensitive polymer waveguide devices is determined by the optical path length nL change over temperature T:

$$\frac{ⅆ ( nL )}{ⅆ T} = \frac{ⅆ n}{ⅆ T} L + \frac{ⅆ L}{ⅆ T} n \qquad Equation 1$$

where n is the refractive index of the polymer waveguide core, L is the length of the optical path, determined by the linear dimension of the substrate 12 at a specific temperature, and T is the temperature of the core and the substrate 12. Therefore, to achieve athermal devices, the following condition should be satisfied:

$$\frac{ⅆ n}{ⅆ T} L + \frac{ⅆ L}{ⅆ T} n = 0 \qquad Equation 2$$

which yields:

$$\frac{1}{n} \frac{ⅆ n}{ⅆ T} = - \frac{1}{L} \frac{ⅆ L}{ⅆ T} \qquad Equation 3$$

where

$$\frac{1}{L} \frac{ⅆ L}{ⅆ T} = {CTE}_{substrate}$$

(Coefficient of Thermal Expansion of the Substrate)

The CTE of a given polymer substrate material can be measured by standard thermal mechanical analyzers, which are well known in the art. The refractive index n and the thermo-optic coefficient

$$\frac{ⅆ n}{ⅆ T}$$

of a given polymer waveguide material can be measured as well, by using temperature controlled optical material or optical waveguide measurements, which are also well known in the art. Once the refractive index n and the thermo-optic coefficient

$$\frac{ⅆ n}{ⅆ T}$$

are determined for a certain waveguide material, the desired CTE can be calculated from Equation 3. However, it is more accurate to use the effective index. The effective index (n_{eff}) is a number between n_{core} and n_{clad}, and tends to closely approximate n_{core} such that, for Equation 3, n_{core} can be used for n.

Polymer materials and blends of polymer materials for the substrate 12 can be selected according to their CTE so that, for a given waveguide material, with a specific thermal optical coefficient

$$\frac{ⅆ n}{ⅆ T}$$

and a specific refractive index n, the athermal condition defined by Equation 3 can be satisfied. If a substrate material with a particular CTE to satisfy Equation 3 is not available based on a selected waveguide core, the thermo-optic coefficient

$$\frac{ⅆ n}{ⅆ T}$$

of the core and the thermal expansion coefficient CTE_{substrate} of the substrate 12 can be adjusted so that Equation 3 is satisfied. The adjustment can be performed by blending various polymers for the substrate 12 and/or the waveguide core to achieve the desired results. Although generally, the equation

$$\frac{1}{n} \frac{ⅆ n}{ⅆ T} = - \frac{1}{L} \frac{ⅆ L}{ⅆ T} ,$$

should be satisfied, those skilled in the art will recognize that the results on each side of the equation can differ by approximately 1% and still generally achieve the desired athermal conditions. For polymers, the thermo-optic coefficient is negative in sign, allowing Equation 3 to be satisfied for conventional positive CTE materials.

In one embodiment, shown graphically in FIG. 1 and schematically in FIG. 2, the amplifier gain medium 14 is optically connected to the AWG 16 in series so that signal light λ_{S} can be transmitted through the amplifier gain medium 14 to the AWG 16.

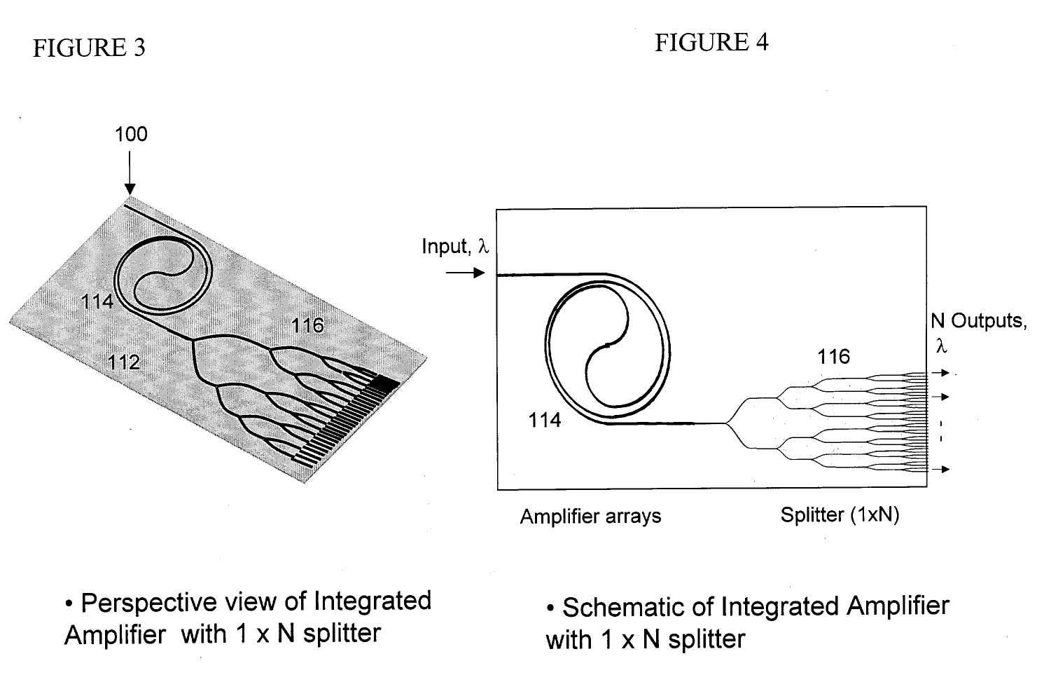

In another embodiment, shown graphically in FIG. 3 and schematically in FIG. 4, an integrated polymer optical waveguide device 100 is disclosed. The waveguide device 100 includes an amplifier gain medium 114 integrated with and optically connected in series to a splitter, such as the 1×32 splitter 116 shown, disposed on a substrate 112. The waveguide device 100 provides overall loss compensation for the splitter 116. For a 1×N splitter, with equal power division at each split, then the gain through the amplifier gain medium 114 must be 3*c dB, where N=2^{c} to achieve loss compensation.

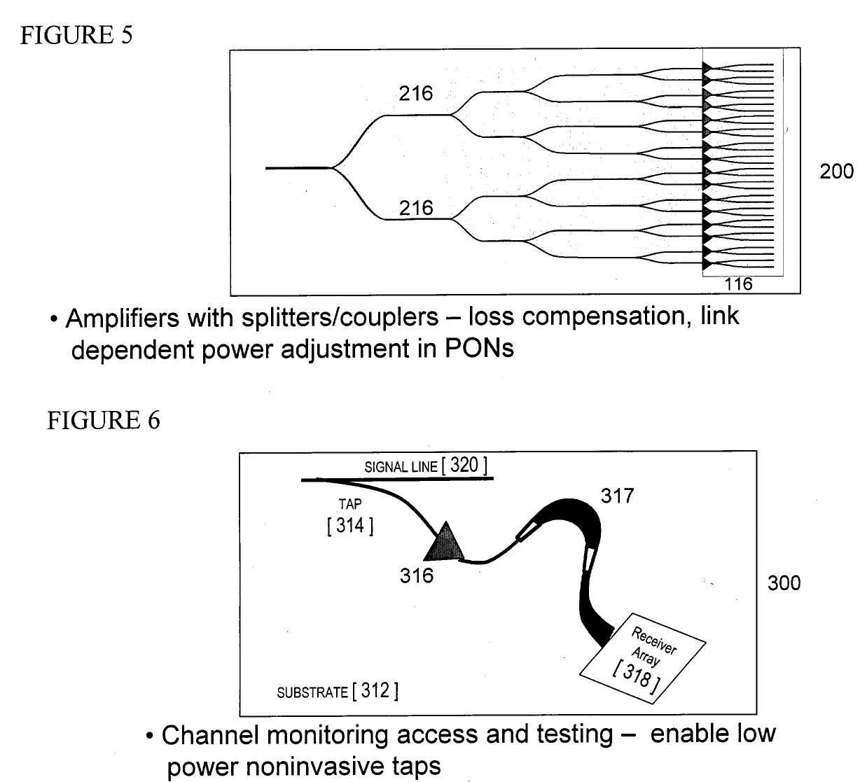

In another embodiment of an integrated waveguide device 200, shown schematically in FIG. 5, a plurality of amplifiers 216 are optically connected in series to each leg of the splitter 116. Such a waveguide device 200 can provide for link dependent power adjustment in passive optical networks or in Community Antenna Television (CATV), or cable television.

Another embodiment of an integrated waveguide device 300 is shown schematically in FIG. 6. In this device 300, a tap 314, an amplifier gain medium 316, an AWG 317, and a receiver array 318 are integrated and optically connected in series onto a substrate 312. In this device 300, a very low percentage (typically approximately 1%) of a light signal λS is tapped from a signal line 320. The tapped signal is amplified in the amplifier gain medium 316, and transmitted through the AWG 317, where discrete wavelengths being transmitted as the light signal λ_{S} are separated and monitored in the receiver array 318.

Although several embodiments of integrated waveguide devices 10, 100, 200, 300 have been shown, those skilled in the art will recognize that other combinations of optical waveguide devices, such as optical gain media, optical splitters, optical combiners, optical multiplexers, optical demultiplexers, optical switches, and optical filters can be used on a single substrate.

Once the waveguide device 10,100, 200, 300 has been made, in some instances, it may be desirable to incorporate an additional controlling thin strip electrode, which can be deposited by lithographic processes, as are well known to those skilled in the art.

For any of the waveguide devices 10,100, 200, 300 in which it may be desirable to use different materials for each device, such as an active and a passive optical material, the waveguide devices 10, 100, 200, 300 can be manufactured according to the teaching of U.S. patent application Ser. No. 10/004,652, filed Dec. 4, 2001, which is owned by the assignee of the present invention and which is incorporated by reference herein in its entirety.

The completed device 10, 100, 200, 300 can then be diced and endfaced to provide good coupling to an optical fiber, which can be attached to the waveguide device 10, 100, 200, 300 by any of various methods, including ferrules, V-groove arrays and other connection methods as will be recognized by those skilled in the art.

Any of the waveguides described above can incorporate the technologies as disclosed in U.S. patent application Ser. No. 09/877,871, filed Jun. 8, 2001, U.S. patent application Ser. No. 09/971,157, filed Oct. 4, 2001, U.S. patent application Ser. No. 10/045,317, filed Nov. 7, 2001, and U.S. Patent Application Serial No. 60/322,162 filed 16 Sep. 2002, all of which are owned by the assignee of the current invention and all of which are incorporated herein by reference in their entireties. Further, the materials that can be used to form the waveguide 10, 100, 200, 300 are disclosed in U.S. Pat. No. 6,292,292, and U.S. patent application Ser. No., 09/722,821, filed Nov. 28, 2000, 09/722,282, filed Nov. 28, 2001, and 60/314,902, filed Aug. 24, 2001, all of which are owned by the assignee of the current invention and all of which are incorporated herein by reference in their entireties.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An integrated optical device formed from a random glassy medium comprising:
a generally planar substrate; and
a plurality of integrated waveguide devices disposed on the substrate.

2. The integrated optical device according to claim 1, wherein said plurality of integrated waveguide devices are chosen from optical amplifier gain media, optical splitters, optical combiners, optical multiplexers, optical demultiplexers, optical switches, optical filters, taps, receiver arrays, and arrayed waveguide gratings.

3. The integrated optical device according to claim 1, wherein the generally planar substrate is an inorganic glass.

4. The integrated optical device according to claim 1, wherein the generally planar substrate is a polymer.

5. The integrated optical device of claim 4, wherein said polymer is chosen from polycarbonate, acrylic, polymethyl methacrylate, cellulosic, thermoplastic elastomer, ethylene butyl acrylate, ethylene vinyl alcohol, ethylene tetrafluoroethylene, fluorinated ethylene propylene, polyetherimide, polyethersulfone, polyetheretherketone, polyperfluoroalkoxyethylene, nylon, polybenzimidazole, polyester, polyethylene, polynorbornene, polyimide, polystyrene, polysulfone, polyvinyl chloride, polyvinylidene fluoride, an ABS polymer (such as polyacrylonitrile butadiene styrene), acetal copolymer, poly [2,2-bistrifluoromethyl-4,5-difluoro-1,3-dioxole-co-tetrafluoroethylene], poly[2,3-(perfluoroalkenyl) perfluorotetrahydrofuran], poly[2,2,4-trifluoro-5-trifluoromethoxy-1,3-dioxole-co-tetrafluoroethylene], and any other thermoplastic polymers; and thermoset polymers.

6. The integrated optical device of claim 5, wherein the thermoset polymers are chosen from diallyl phthalate, epoxy, furan, phenolic, thermoset polyester, polyurethane, and vinyl ester.

7. The integrated optical device according to claim 1, wherein the generally planar substrate is a polymer nanocomposite.

8. The integrated optical device according to claim 1, wherein the device is athermal to the extent that, the product of the thermo-optic coefficient of the polymer waveguide core and the reciprocal of the refractive index of the polymer waveguide core being approximately equal to the negative value of the coefficient of thermal expansion.

9. The integrated optical device according to claim 1, wherein the gain media comprises dopants chosen from rare earth ions, transition metal ions or nanoparticles for desired bandwidth amplification.

10. The integrated optical device of claim 9, wherein the rare earth ions are chosen from Erbium for C-L band, Thulium for S-Band, and Praseodymium for O-band.

11. The integrated optical device of claim 9, wherein the transition metal ion is Chromium for O-band.

12. The integrated optical device of claim 1, wherein the optical device exhibits absorption losses less than or approximately 0.1 dB/cm across the range of wavelength from about 1200 nm to about 1700 nm.

13. The integrated optical device of claim 2, wherein the amplifier gain medium is chosen from a generally circular double spiral structure.

14. The integrated optical device of claim 2, wherein the amplified gain medium is optically connected to an arrayed waveguide grating (AWG) in series so that signal light, λ_{S}, can be transmitted through the amplifier gain medium to the AWG.

15. The integrated optical device of claim 2, wherein the integrated waveguide devices include an amplifier gain medium integrated with and optically connected in series to an optical splitter disposed on said substrate.

16. The integrated optical device of claim 2, wherein a plurality of amplifiers are optically connected in series to each leg of a splitter.

17. The integrated optical device of claim 2, wherein an amplifier gain medium, an arrayed waveguide grating (AWG), and a receiver array are integrated and optically connected in series onto said substrate.
